(19) United States
(12) Patent Application Publication
(10) Pub. No.: US 2025/0112864 A1
(43) Pub. Date: Apr. 3, 2025

(54) CONGESTION DETECTION IN INTERCONNECTION NETWORKS

(71) Applicant: Intel Corporation, Santa Clara, CA (US)

(72) Inventors: Hossein FARROKHBAKHT, Toronto (CA); Kartik LAKHOTIA, San Jose, CA (US); Fabrizio PETRINI, Menlo Park, CA (US)

(21) Appl. No.: 18/980,933

(22) Filed: Dec. 13, 2024

(51) Int. Cl. H04L 47/12; H04L 5/00; H04L 47/11; H04L 47/17

(52) U.S. Cl. CPC H04L 47/12; H04L 5/0055; H04L 47/11; H04L 47/17

(57) ABSTRACT

Examples described herein relate to switch circuitry that is to: detect congestion based on information and based on detection of the congestion, perform a congestion mitigation action. In some examples, detect congestion based on the information includes: access a first value that indicates a number of packets received at a first input port and to be egressed from an output port of the multiple output ports, access a second value that indicates a number of packets received at a second input port and to be egressed from the output port, and generate the information based on the first value and the second value.

### BACKGROUND

Networks provide connectivity among multiple processors, memory devices, and storage devices for distributed performance of processes. Congestion is a condition that arises in a network when a traffic load surpasses available bandwidth and memory capacity, resulting in packet dropping and a decrease in network performance. Endpoint congestion occurs when an endpoint is unable to receive packets at an incoming rate of packets. Incast traffic occurs when there are multiple streams of packets competing with each other to get ejected to a same destination from the same port of the final router in the path. Network congestion occurs when multiple packets are destined for a single output port on a router, but their final destinations are not necessarily the same.

### BRIEF DESCRIPTION OF THE DRAWINGS

FIG. 1 depicts an example switch.

FIG. 2 depicts an example switch system.

FIG. 3 depicts an example of output port arbitration.

FIG. 4 depicts an example of arbitration.

FIG. 5 depicts an example of an arbiter.

FIGS. 6A to 6B depict examples of an arbiter.

FIG. 7 depicts an example process.

FIG. 8 depicts an example switch.

FIG. 9 depicts an example system.

### DETAILED DESCRIPTION

A network on chip (NoC) design can provide a cornerstone of correctness by being free of deadlock. For an interconnection network, correctness can include a guarantee of delivery of a transmitted packet to a destination receiver. An interconnect design ensures correctness by preventing deadlock, which occurs when a group of agents that share some resources remain in a perpetual waiting state due to a circular dependency. In an interconnect of a large-scale system, the agents are packets, and the resources are buffers that store incoming packets as they traverse the network to reach the destinations. The interconnection network can experience routing-level deadlock in which packets cease to progress and cause the system to malfunction. To achieve deadlock-free communication, some trade-offs are involved, such as virtual channels, performance issues and/or hardware complexity.

Various examples can detect both endpoint congestion and network congestion based on information sent to multiple input ports so that input ports can determine whether endpoint congestion or network congestion have occurred. In some examples, the information can include a total number of flits (e.g., packets) destined per one or more output ports of a NoC. This information can be propagated to input ports within the NoC. Various examples can provide advantages, but not necessarily features, such as rapid congestion detection for endpoint and network congestion, apply to different topology types, apply to high-radix and low-radix routers, apply to different protocol models including shared-memory and distributed-memory communication protocols, and apply to different routing algorithms.

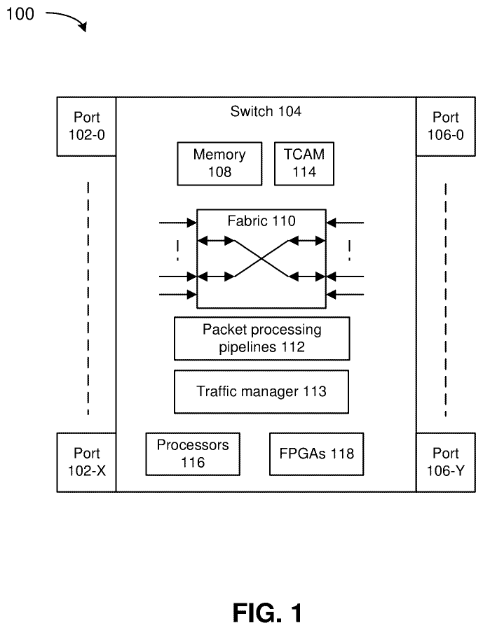

FIG. 1 depicts an example switch. Various examples of switch 100 can be used in a NoC to perform operations described herein to detect congestion by determining a volume of packets transmitted from an output port of the switch. Switch 104 can route packets, flits, or frames of any format or in accordance with any specification from any port 102-0 to 102-X to one or more of ports 106-0 to 106-Y (or vice versa). One or more of ports 102-0 to 102-X can be connected to a network of one or more interconnected devices. Similarly, one or more of ports 106-0 to 106-Y can be connected to a network of one or more interconnected devices.

In some examples, switch fabric 110 can provide routing of packets from one or more ingress ports for processing prior to egress from switch 104. Switch fabric 110 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 108 can be configured to store packets received at ports prior to egress from one or more ports. Packet processing pipelines 112 can include ingress and egress packet processing circuitry to respectively process ingressed packets and packets to be egressed. Packet processing pipelines 112 can determine which port to transfer packets or frames to using a table that maps packet characteristics with an associated output port. Packet processing pipelines 112 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 112 can implement access control list (ACL) or packet drops due to queue overflow. Packet processing pipelines 112, processors 116, and/or FPGAs 118 can be configured to determine output traffic volume, as described herein.

Configuration of operation of packet processing pipelines 112, including its data plane, can be programmed using Programming Protocol-independent Packet Processors (P4), C, Python, Broadcom Network Programming Language (NPL), or x86 compatible executable binaries or other executable binaries.

Traffic manager 113 can perform hierarchical scheduling and transmit rate shaping and metering of packet transmissions from one or more packet queues. Traffic manager 113 can perform congestion management such as flow control, congestion notification message (CNM) generation and reception, priority flow control (PFC), and others.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

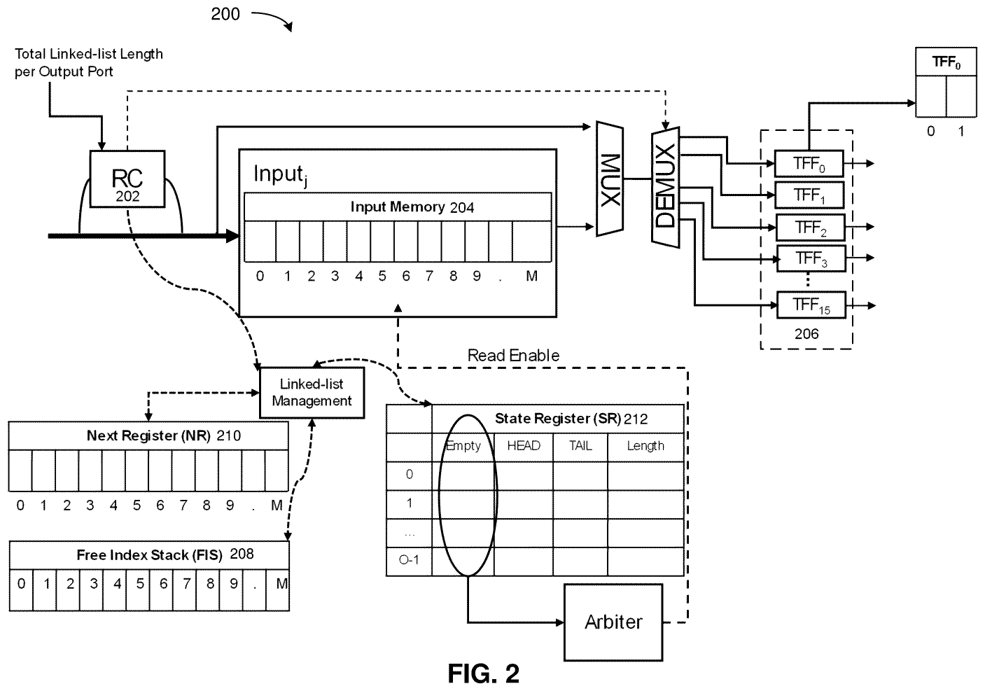

FIG. 2 illustrates an example system. For simplicity of description, one input port and one output port are represented. However, the system can be utilized for multiple input ports that provide packets to multiple output ports. Based on receipt of a packet, route compute (RC) unit 202 can determine an output port based on source and destination information in the packet header and routing configuration. A port identifier (ID) associated with the selected output port can be used to select a row number in state register (SR) 212 from which to access an entry for the output port. RC unit 202 can determine whether to store a packet received in a memory slot in input memory 204 or in bypass buffer 206 allocated to the selected output port for the packet based on availability in bypass buffer 206.

Shared memory 204 at an input port can be used to store packets to be egressed to one or more output ports. These packets can be read into smaller per output port buffers (e.g., Tree Flit FIFO (TFFs) 206) for further arbitration. If a TFF corresponding to an output port has free space, a packet can bypass shared memory 204 and be written into a TFF for the output port directly. Input memory 204 may store multiple linked lists, one for each output port and/or message type. Support structures for the linked lists can include a state register, which can store the head and tail pointers for each linked list and the free index stack which can store the list of free locations in memory and next register which stores the next pointer to write-to.

For an input port, O number of bypass buffers 206 (e.g., TFFs) can be used, where O represents a number of output ports. For example, RC 202 can direct a packet to bypass buffer 206 when bypass buffer 206 is not full and otherwise direct the packet to input memory 204 to store the packet when bypass buffer 206 is full. Based on availability to store a packet in a buffer 206, RC 202 can cause a packet to traverse a bypass path to buffer 206 for the output port for the packet. For example, an incoming packet flit can bypass input memory 204 if the corresponding linked list an entry in SR 212 is empty and the corresponding buffer 206 has free space. In this example, a bypass buffer 206 for an output port stores 2 packets, but other numbers of packets can be stored in bypass buffer 206.

Input memory 204 can be allocated to store multiple different types of packets (e.g., request (e.g., load or store), response (e.g., load response of data), or others), and different message types can occupy a certain number of entries in input memory 204 to reduce a likelihood of protocol-level deadlock or HoL blocking among different types of messages. The number of entries per message type can be based on the round-trip latency between the routers. For example, N counters can be used to track the number of available slots in input memory 204, where N is the number of message types.

Various examples can utilize Free Index Stack (FIS) 208 and Next Register (NR) 210 to track available regions in input memory 204 and utilize state register (SR) 212 to track packets available for an output port. For example, FIS 208 can include a register that tracks free entries in memory 204. In some examples, a single FIS 208 can be utilized per input port so that different instances of FIS 208 can be utilized for different input ports. However, a single instance of FIS 208 can be utilized for multiple input ports. FIS 208 can be implemented as a free linked list and can receive a 1 pop and 1 push request per clock cycle, and returns a free slot in memory 204 in a single clock cycle. For example, NR 210 can include a register that is to store an indicator of a next available entry in memory 204.

For example, SR 212 can track a number of flits addressed to one or more output ports. A number of rows in SR 212 can represent a number output ports. An SR can have O number elements, where O is the number of output ports in the router. A row can be allocated to an output port so that the row tracks the flits destined for the output port. In other words, rowᵢ of the SR 212 can track flits destined for output portᵢ. An SR can be allocated per input port and/or per message type. An entry in SR 212 can include the following fields: empty field, head pointer to the next pointer (NP) that indicates a next index to be accessed in IM 204, a tail pointer to the NP that indicates a last index to be accessed in a linked list, and length field. The empty field can indicate if the linked list is empty or not. In other words, empty field can indicate if there are any flits at this input port destined for a corresponding output port. When the empty field of a row is 1, the list is empty and no flits are destined for the output port corresponding to the row. The head pointer can indicate a first packet in input memory 204 to be egressed to a bypass buffer 206 for an output port. The tail pointer can indicate a final packet in input memory 204 to be egressed to bypass buffer 206 for the output port. The length field can indicate a number of packets that are to be transmitted to a particular output port (e.g., a size of a linked-list for packets to be egressed from the output port). Multiple SRs can be allocated per input port, such as one SR per message type.

Using data in SR 212, RC 202 can determine a number of flits from an input port destined per output port (Loadᵢ). In some examples, the total number of flits that exist in the input ports destined for output port i can be calculated using following formula:

$${Load}_{i} = {{\sum }_{j = 0}}^{In = \# input ports} Length of {SR}_{i}^{j}$$

where SRᵢ^{j} is the length of the SR row i in the SR table of input port j.

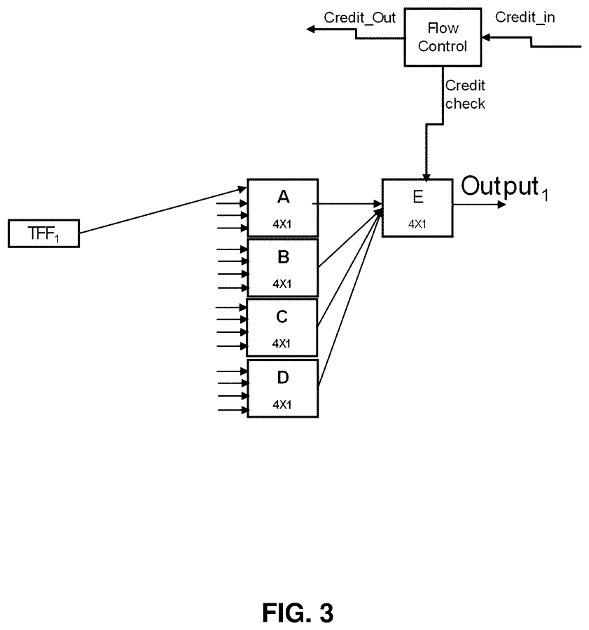

RC 202 can perform calculation of length for an output port based on progress of packets through input memory 204 and bypass buffers 206 to the output ports. For example, at or after one or more clock cycles, an input port can send the linked-list length of SRᵢ to a corresponding arbitration circuitry (e.g., arbiters A, B, C and D shown in FIG. 3). Then, the arbitration circuitries can forward partial sums to an arbiter E, which can calculate a length (e.g., total number of flits from input ports of the switch destined to a single output port).

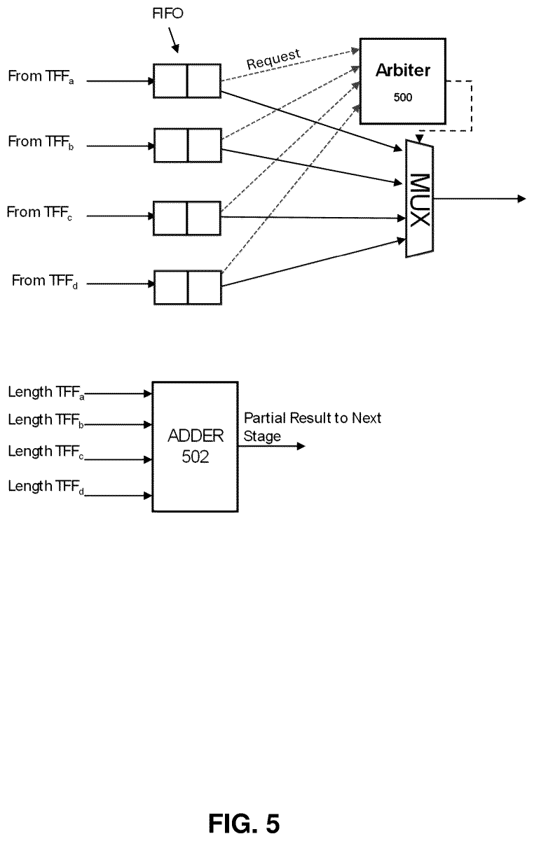

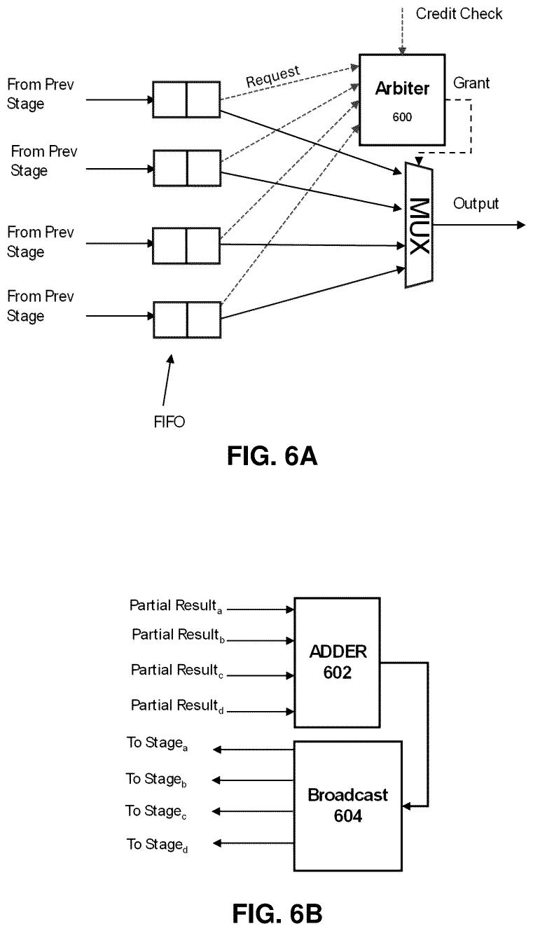

For example, as shown in FIG. 5, arbitration circuitry can include an unsigned adder that receives four X-bit inputs of total flits destined per output port from four input ports. The load values may also be quantized to a smaller number of bits to reduce the resource requirements for computation and distribution of the load information. For example, as shown in FIGS. 6A and 6B, after propagation of partial sums from arbitration circuities A-D to arbitration circuitry E, in the reverse direction, arbitration circuitry E can broadcast the final length to input ports for corresponding RCs to calculate a number of packets to be egressed to a particular output port from the input ports.

Referring again to FIG. 2, route compute unit 202 associated with an input port can determine the load for one or more of the output ports and can detect congestion based on the determined load. For example, if a sum of loads for the output ports is at or more than a configured level, route compute unit 202 can detect congestion at the input port. Congestion can be caused by network congestion based on a next hop comprising a switch. Congestion can be caused by an endpoint based on a next hop comprising an endpoint. RC 202 can perform a congestion mitigation action that includes one or more of: drop a packet to be egressed to a next hop that is not an endpoint and send a negative acknowledgement (NACK) for the dropped packet to a sender device, or select another path for packets of one or more flows that are to egress from an output port considered congested.

Route compute unit 202 can select an output port whose load is at or below a particular configured level and update the routing path to a destination device for packets from the input port. If the router is the final destination, and the output port load is greater than the configurable threshold, this indicates an endpoint congestion. In some examples, route compute unit 202 can drop the packet and generate a network NACK to the sender of a packet that is dropped, so the sender can select another path using adaptive routing if a source-routing is employed. Upon receipt of the endpoint NACK, the sender can react accordingly and adjust its sending rate using a congestion control mechanism.

Various congestion control schemes can be applied by route compute unit 202. For example, RC 202 can perform Explicit Congestion Notification (ECN), defined in RFC 3168 (2001), allows end-to-end notification of network congestion whereby the receiver of a packet echoes a congestion indication to a sender. A packet sender can reduce its packet transmission rate in response to receipt of an ECN. Use of ECN can lead to packet drops if detection and response to congestion is slow or delayed. TCP CC is based on heuristics from measures of congestion such as network latency or the number of packet drops.

RC 202 can perform other congestion control schemes including Google's Swift, Amazon's SRD, and Data Center TCP (DCTCP), described for example in RFC-8257 (2017). DCTCP is a TCP congestion control scheme whereby when a buffer reaches a threshold, packets are marked with ECN and the end host receives markings and sends the marked packets to a sender. The sender can adjust its transmit rate by adjusting a congestion window (CWND) size to adjust a number of sent packets for which acknowledgement of receipt was not received. In response to an ECN, a sender can reduce a CWND size to reduce a number of sent packets for which acknowledgement of receipt was not received. Swift, SRD, DCTCP, and other CC schemes adjust CWND size based on indirect congestion metrics such as packet drops or network latency.

RC 202 can perform a congestion control scheme such as High Precision Congestion Control (HPCC) for remote direct memory access (RDMA) communications that provides congestion metrics to convey precise link load information. HPCC is described at least in Li et al., “HPCC: High Precision Congestion Control,” SIGCOMM (2019). HPCC leverages in-network telemetry (INT) (e.g., Internet Engineering Task Force (IETF) draft-kumar-ippm-ifa-01, “Inband Flow Analyzer” (February 2019)). HPCC uses in-band telemetry INT to provide congestion metrics measured at intermediary switches.

A packet may be used herein to refer to various formatted collections of bits that may be sent across a network, such as Ethernet frames, Internet Protocol (IP) packets, Transmission Control Protocol (TCP) segments, User Datagram Protocol (UDP) datagrams, etc.

A flow can include a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

In some examples, switch 200 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding device can include a router and/or switch.

FIG. 3 depicts an example of arbitration to an output port. In this example, 16 input ports can utilize 16 bypass buffers for 16 output ports. In some examples, multiple level arbitration can be utilized. For example, a first arbiter (A) can be assigned to arbitrate a first set of 4 input ports, a second arbiter (B) can be assigned to arbitrate a second set of 4 input ports, a third arbiter (C) can be assigned to arbitrate a third set of 4 input ports, and a fourth arbiter (D) can be assigned to arbitrate a fourth set of 4 input ports. Such multiple level arbitration configuration can reduce a number of wires utilized to couple input ports to an output port.

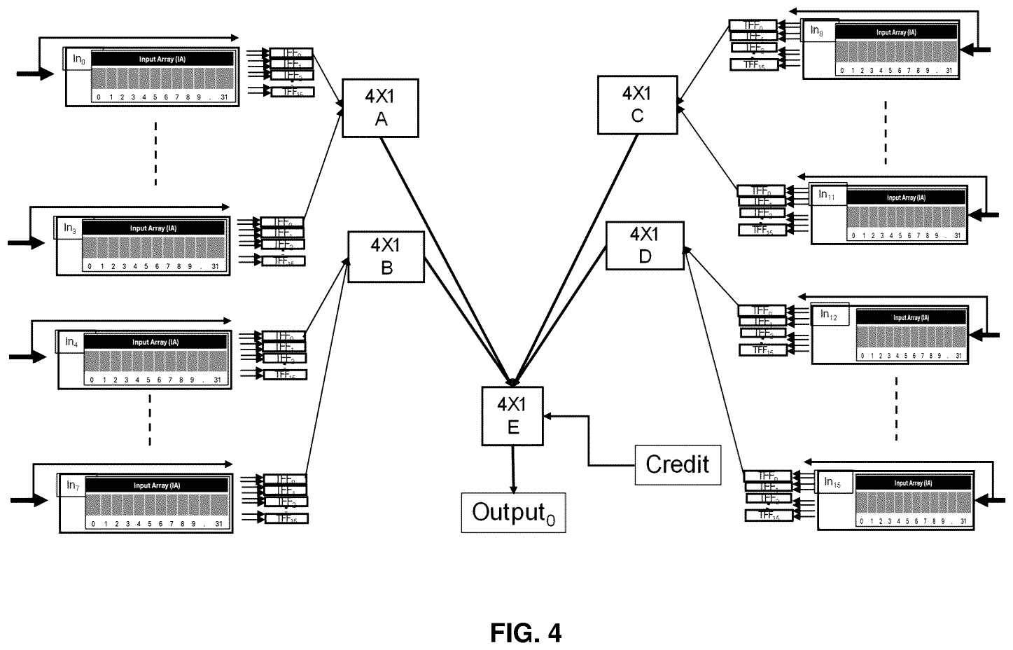

FIG. 4 depicts an example of output port arbitration. In some examples, multiple level arbitration can be utilized. As mentioned, N number of counters per output port can track the availability slots in an Input Memory for an input port. Credit signals can be asserted corresponding to a message type and the corresponding upstream counter is incremented by 1 based on the flit skipping the Input Memory to a bypass buffer or when the packet is read from the Input Memory to be written into the corresponding bypass buffer. If an incoming flit can skip the Input Memory while another flit (e.g., same message type) is read from the memory, the corresponding upstream counter can be incremented by 2. The credit signals can be fed to the output stage E, and credit propagation to the input stage may not occur. Compared to a multi-VC design, examples can reduce the number of wirings and cell count, while improving throughput by eliminating the HoL blocking.

FIG. 5 depicts an example of an arbiter. Arbiter 500 can represent arbiter A, B, C, or D. Requests can be issued from bypass buffers of a group of 4 input ports to arbiter A. Similarly, requests can be issued from bypass buffers of a second group of 4 input ports to arbiter B; requests can be issued from bypass buffers of a third group of 4 input ports to arbiter C; and requests can be issued from bypass buffers of a fourth group of 4 input ports to arbiter D. Arbiter 500 can select a flit to forward to a next arbiter (e.g., arbiter E) by round robin, weighted round robin, or other schemes. Arbiter 500 can cause multiplexer (MUX) to select a packet to forward based on selection of the flit to forward.

For example, one or more of arbiters A-D can include adder 502. In a forward direction, adder 502 can calculate total flits destined per output port and provide the partial result to a next stage (e.g., arbiter E).

FIG. 6A depicts an example of an arbiter. Arbiter 600 can receive inputs of selected flits from an instance of arbiter 500 of stages A-D and select a flit to output from an output port by round robin, weighted round robin, or other schemes. In addition, as shown in FIG. 6B, arbiter 600 can perform length computation from total flits received and to be received from input ports associated with arbiters A-D. Adder 602 can calculate a final length of flits for the output port and broadcast 604 the total length to input ports over the reverse direction through arbiters A-D.

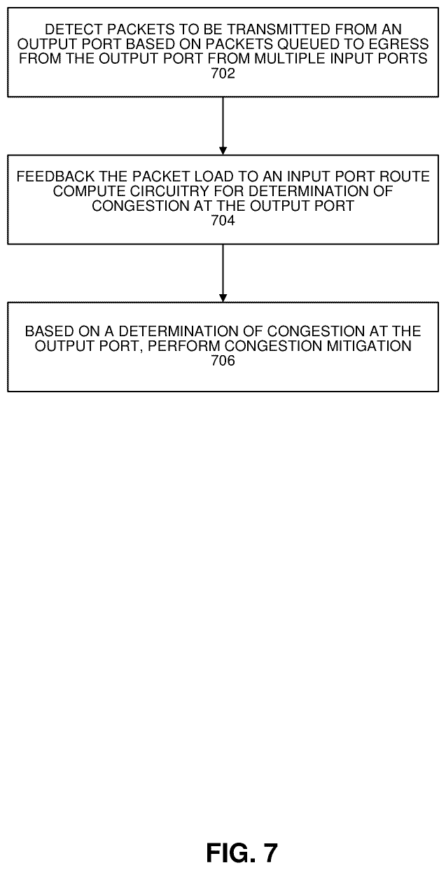

FIG. 7 depicts an example process. The process can be performed by a switch in some examples. At 702, an arbitration circuitry for an output port of the switch can detect packet traffic to be transmitted from one or more input ports. For example, packet traffic to be transmitted from one or more input ports can be forward propagated to the arbitration circuitry, the arbitration circuitry can calculate the volume of packets to be transmitted from the output port, and at 704, the output port can indicate such traffic volume to the input port. For example, at 704, the input port route calculator can determine whether the traffic volume to an output port indicates congestion at the output port. At 706, based on a determination of congestion at the output port, the route compute circuitry can perform a congestion control scheme including changing an output port for a packet, or other schemes.

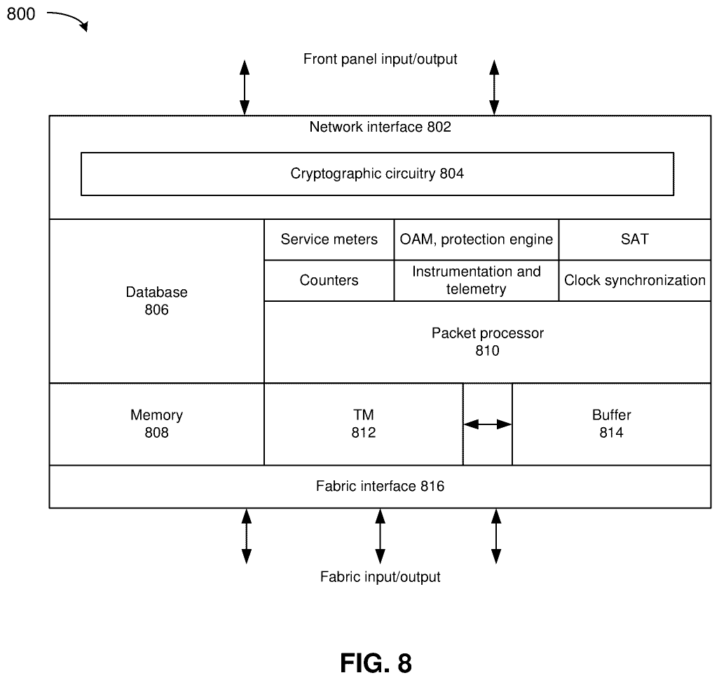

FIG. 8 depicts an example switch. Various examples can be used in or with the switch to perform operations to detect congestion based on packets to be transmitted from an output port from one or more input ports described at least with respect to FIG. 1. Switch 800 can include a network interface 800 that can provide an Ethernet consistent interface. Network interface 800 can support for 25 GbE, 50 GbE, 100 GbE, 200 GbE, 400 GbE Ethernet port interfaces. Cryptographic circuitry 804 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 806 can store a device's profile to configure operations of switch 800. Memory 808 can include High Bandwidth Memory (HBM) for packet buffering. Packet processor 810 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 810 can include one or more FPGAs. Buffer 814 can store one or more packets. Traffic manager (TM) 812 can provide per-subscriber bandwidth guarantees in accordance with service level agreements (SLAs) as well as performing hierarchical quality of service (QOS). Fabric interface 816 can include a serializer/de-serializer (SerDes) and provide an interface to a switch fabric. A switch SoC can be coupled to other devices in a switch system such as ingress or egress ports, memory devices, or host interface circuitry.

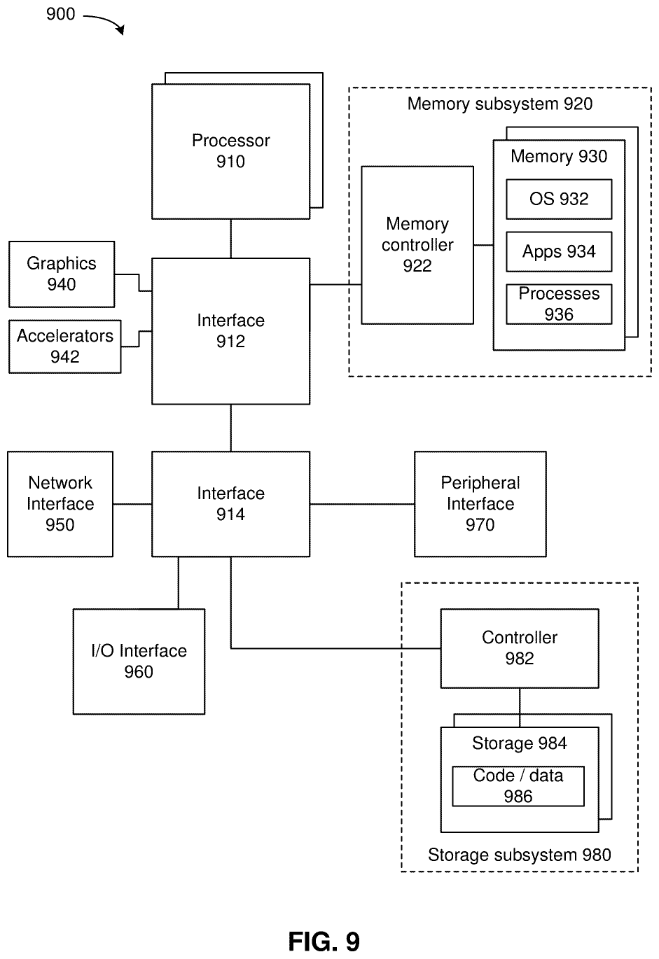

FIG. 9 depicts a system. In some examples, network interface 950 can be configured to perform operations to detect congestion based on packets to be transmitted from an output port from one or more input ports, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

In some examples, OS 932, a system administrator, and/or orchestrator can configure network interface 950 to perform operations to detect congestion based on packets to be transmitted from an output port from one or more input ports.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, packet processing device or network interface device 950 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIGS. 21A and 21B.

In one example, system 900 includes one or more input/output (I/O) interface(s) 960. I/O interface 960 can include one or more interface components through which a user interacts with system 900. Peripheral interface 970 can include any hardware interface not specifically mentioned above. Peripherals refer generally to devices that connect dependently to system 900.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 900 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: first interfaces to multiple input ports; second interfaces to multiple output ports; and switch circuitry, coupled to the first interfaces and the second interfaces, wherein the switch circuitry is to: detect congestion based on information, wherein the information comprises a number of packets from the multiple input ports to be transmitted from the multiple outputs ports and wherein the detect congestion based on the information comprises: access a first value that indicates a number of packets received at a first input port and to be egressed from an output port of the multiple output ports, access a second value that indicates a number of packets received at a second input port and to be egressed from the output port, and generate the information based on the first value and the second value; and based on detection of the congestion, perform a congestion mitigation action.

Example 2 includes one or more examples, wherein the congestion comprises endpoint congestion based on a next hop that includes an endpoint.

Example 3 includes one or more examples, wherein the congestion comprises network congestion based on a next hop that includes a switch.

Example 4 includes one or more examples, wherein the congestion mitigation action comprises one or more of: drop a packet to be egressed to a next hop that is not an endpoint and send a negative acknowledgement (NACK) to a sender device, or select another path for packets that are to egress from an output port considered congested.

Example 5 includes one or more examples, wherein the switch circuitry is to perform calculation of the information based on progress of packets through memory regions and buffers to at least one of the multiple outputs ports.

Example 6 includes one or more examples, and includes: one or more arbiters, wherein the one or more arbiter are to calculate packet traffic volume to an output port and feedback the packet traffic volume to the switch circuitry.

Example 7 includes one or more examples, wherein the one or more arbiters comprise multiple levels of arbiters to receive packets and to arbitrate egress from the output port.

Example 8 includes one or more examples, and includes: a region in a memory allocated to packets of an input port of the multiple input ports and a buffer allocated to one or more of the multiple output ports, wherein egress from an output port of the multiple output ports occurs from the buffer, wherein the number of packets from the multiple input ports is based on packets allocated in the memory region and the buffer.

Example 9 includes one or more examples, and includes a method that includes: configuring one or more routers in a network to: detect congestion based on information, wherein the information comprises a number of packets from multiple input ports to be transmitted from multiple outputs ports and based on detection of the congestion, perform a congestion mitigation action.

Example 10 includes one or more examples, wherein the congestion comprises endpoint congestion based on a next hop that includes an endpoint.

Example 11 includes one or more examples, wherein the congestion comprises network congestion based on a next hop that includes a switch.

Example 12 includes one or more examples, wherein the congestion mitigation action comprises one or more of: drop a packet to be egressed to a next hop that is not an endpoint and send a negative acknowledgement (NACK) to a sender device, or select another path for packets that are to egress from an output port considered congested.

Example 13 includes one or more examples, and includes performing calculation of the information based on progress of packets through memory regions and buffers to at least one of the multiple outputs ports.

Example 14 includes one or more examples, and includes one or more arbiters for an output port are to calculate packet traffic volume to the output port and providing the packet traffic volume to circuitry associated with an input port of a router of the one or more routers.

Example 15 includes one or more examples, wherein the network comprises one or more of: a mesh, network on chip (NoC), or off-chip network.

Example 16 includes one or more examples, and includes at least one computer-readable medium that includes instructions stored thereon, that if executed by one or more circuitry of a router, cause the one or more circuitry of the router to: detect congestion based on information, wherein the information comprises a number of packets from multiple input ports to be transmitted from multiple outputs ports and based on detection of the congestion, perform a congestion mitigation action.

Example 17 includes one or more examples, wherein: the congestion comprises endpoint congestion based on a next hop that includes an endpoint and the congestion comprises network congestion based on a next hop that includes a switch.

Example 18 includes one or more examples, wherein the congestion mitigation action comprises one or more of: drop a packet to be egressed to a next hop that is not an endpoint and send a negative acknowledgement (NACK) to a sender device, or select another path for packets that are to egress from an output port considered congested.

Example 19 includes one or more examples, and includes instructions stored thereon, that if executed by one or more circuitry of a router, cause the one or more circuitry of the router to: calculate the information based on progress of packets through memory regions and buffers to at least one of the multiple outputs ports.

Example 20 includes one or more examples, wherein: one or more arbiters for an output port are to calculate packet traffic volume to the output port and providing the packet traffic volume to circuitry associated with an input port of a router of the one or more routers.

1. An apparatus comprising:
first interfaces to multiple input ports;
second interfaces to multiple output ports; and
switch circuitry, coupled to the first interfaces and the second interfaces, wherein the switch circuitry is to:
detect congestion based on information, wherein the information comprises a number of packets from the multiple input ports to be transmitted from the multiple outputs ports and wherein the detect congestion based on the information comprises:
access a first value that indicates a number of packets received at a first input port and to be egressed from an output port of the multiple output ports,
access a second value that indicates a number of packets received at a second input port and to be egressed from the output port, and
generate the information based on the first value and the second value; and
based on detection of the congestion, perform a congestion mitigation action.

2. The apparatus of claim 1, wherein the congestion comprises endpoint congestion based on a next hop comprising an endpoint.

3. The apparatus of claim 1, wherein the congestion comprises network congestion based on a next hop comprising a switch.

4. The apparatus of claim 1, wherein the congestion mitigation action comprises one or more of: drop a packet to be egressed to a next hop that is not an endpoint and send a negative acknowledgement (NACK) to a sender device, or select another path for packets that are to egress from an output port considered congested.

5. The apparatus of claim 1, wherein the switch circuitry is to perform calculation of the information based on progress of packets through memory regions and buffers to at least one of the multiple outputs ports.

6. The apparatus of claim 1, comprising:
one or more arbiters, wherein the one or more arbiter are to calculate packet traffic volume to an output port and feedback the packet traffic volume to the switch circuitry.

7. The apparatus of claim 6, wherein the one or more arbiters comprise multiple levels of arbiters to receive packets and to arbitrate egress from the output port.

8. The apparatus of claim 1, comprising:
a region in a memory allocated to packets of an input port of the multiple input ports and
a buffer allocated to one or more of the multiple output ports, wherein egress from an output port of the multiple output ports occurs from the buffer, wherein the number of packets from the multiple input ports is based on packets allocated in the memory region and the buffer.

9. A method comprising:
configuring one or more routers in a network to:
detect congestion based on information, wherein the information comprises a number of packets from multiple input ports to be transmitted from multiple outputs ports and
based on detection of the congestion, perform a congestion mitigation action.

10. The method of claim 9, wherein the congestion comprises endpoint congestion based on a next hop comprising an endpoint.

11. The method of claim 9, wherein the congestion comprises network congestion based on a next hop comprising a switch.

12. The method of claim 9, wherein the congestion mitigation action comprises one or more of: drop a packet to be egressed to a next hop that is not an endpoint and send a negative acknowledgement (NACK) to a sender device, or select another path for packets that are to egress from an output port considered congested.

13. The method of claim 9, comprising:
performing calculation of the information based on progress of packets through memory regions and buffers to at least one of the multiple outputs ports.

14. The method of claim 9, comprising:
one or more arbiters for an output port are to calculate packet traffic volume to the output port and providing the packet traffic volume to circuitry associated with an input port of a router of the one or more routers.

15. The method of claim 9, wherein the network comprises one or more of: a mesh, network on chip (NoC), or off-chip network.

16. At least one computer-readable medium comprising instructions stored thereon, that if executed by one or more circuitry of a router, cause the one or more circuitry of the router to:
detect congestion based on information, wherein the information comprises a number of packets from multiple input ports to be transmitted from multiple outputs ports and
based on detection of the congestion, perform a congestion mitigation action.

17. The computer-readable medium of claim 16, wherein:
the congestion comprises endpoint congestion based on a next hop comprising an endpoint and
the congestion comprises network congestion based on a next hop comprising a switch.

18. The computer-readable medium of claim 16, wherein the congestion mitigation action comprises one or more of: drop a packet to be egressed to a next hop that is not an endpoint and send a negative acknowledgement (NACK) to a sender device, or select another path for packets that are to egress from an output port considered congested.

19. The computer-readable medium of claim 16, comprising instructions stored thereon, that if executed by one or more circuitry of a router, cause the one or more circuitry of the router to:
calculate the information based on progress of packets through memory regions and buffers to at least one of the multiple outputs ports.

20. The computer-readable medium of claim 16, wherein:
one or more arbiters for an output port are to calculate packet traffic volume to the output port and providing the packet traffic volume to circuitry associated with an input port of a router of the one or more routers.
